(19) United States
(12) Patent Application Publication
(10) Pub. No.: US 2014/0246930 A1
(43) Pub. Date: Sep. 4, 2014

(54) Cooling Assembly for Electric Machines

(71) Applicant: TM4 Inc., BOUCHERVILLE (CA)

(72) Inventors: Bruno Carpentier, St-Basile Le-Grande (CA); Yannick Rainville, Saint-Jean-sur-Richelieu (CA)

(73) Assignee: TM4 Inc., BOUCHERVILLE (CA)

(21) Appl. No.: 14/350,243

(22) PCT Filed: Nov. 6, 2012
(86) PCT No.: PCT/CA2012/001039

§ 371 Date: Apr. 7, 2014

Related U.S. Application Data
(60) Provisional application No. 61/557,086, filed on Nov. 8, 2011.

(51) Int. Cl. H02K 9/00; H02K 1/16; H02K 3/12; H02K 15/085

(52) U.S. Cl. CPC H02K 9/00; H02K 15/085; H02K 1/16; H02K 3/12
USPC 310/52; 165/168; 165/67; 29/596

(57) ABSTRACT

A cooling arrangement for the stator of an electric machine provided with coils including heads is described herein. The cooling arrangement includes a generally cylindrical cooling body provided with opposite longitudinal ends. Heat transfer material embeds the heads of the coils and contact the cooling body. A coil head embedding assembly and method are also described herein.

### FIELD

The present disclosure generally relates to electric machines. More specifically, the present disclosure is concerned with a cooling assembly to cool the stator of an electric machine.

### BACKGROUND

Stators of electric machines are routinely made of a stack of laminations provided with coil receiving slots defined by projecting teeth. In some instances, prewound coils, for example made of rectangular wires, are to be inserted in these coil-receiving slots. These prewound coils include two generally longitudinal legs to be inserted in the slots and two generally curved heads that interconnect and are often integral with the longitudinal legs. These coil heads project from the laminations and are conventionally not in contact therewith.

When the electric machine is in operation, heat is generated in the coils. Accordingly, a cooling arrangement is provided to extract heat from the laminations which are in contact with the coils and are therefore heated thereby. However, conventional cooling arrangements are generally associated only with the laminations and therefore heat extraction from the coil heads is not optimal since the coil heads are not in contact therewith.

### BRIEF DESCRIPTION OF THE DRAWINGS

In the appended drawings:

FIG. 1 is a perspective view of a stator of an electric machine prior to the installation of the cooling medium about the coil heads;

FIG. 2 is a sectional view of the stator of FIG. 1 ready to be inserted in a coil head embedding assembly according to a first illustrative embodiment;

FIG. 3 is a sectional view similar to FIG. 2, illustrating the stator inserted in the coil head embedding assembly;

FIG. 4 is a sectional view similar to FIG. 2 showing the first heads of the coils being embedded;

FIG. 5 is a sectional view similar to FIG. 4, where the cooling medium is cured;

FIG. 6 is a sectional view illustrating the stator ready to have the second heads of the coils inserted in the embedding assembly;

FIG. 7 is a sectional view of the stator of FIG. 1 inserted in a coil head embedding assembly according to a second illustrative embodiment;

FIG. 8 is a sectional view similar to FIG. 7, showing both heads of the coils being embedded;

FIG. 9 is a sectional view similar to FIG. 8 where the cooling medium is cured;

FIG. 10 is a sectional view illustrating the stator being removed from the embedding assembly; and

FIG. 11 is a sectional view of the stator of FIG. 1 inserted in a coil head embedding assembly according to a third illustrative embodiment.

### DETAILED DESCRIPTION

According to an illustrative aspect, there is provided a cooling arrangement for the stator of an electric machine provided with coils including heads; the cooling arrangement comprising:
a cooling body so configured as to be placed in contact with the stator and provided with opposite longitudinal ends; and
heat-conducting material embedding the heads of the coils and contacting the cooling body.

According to another aspect, there is provided a stator of an electric machine comprising:
a stack of laminations provided with longitudinal slots and with a cooling surface configured to be placed in contact with a cooling body;
at least one coil including straight portions inserted in longitudinal slots of the laminations; the at least one coil including longitudinally positioned heads;
a cooling body in contact with the cooling surface of the laminations; the cooling body being provided with opposite longitudinal ends;
heat-conducting medium embedding the heads of the coils and contacting the cooling body.

According to another aspect, there is provided a coil head embedding assembly to embed the coil heads of the coils of a stator of an electric machine into a heat-conducting medium, the assembly comprising:
a bottom wall and an outer wall;
an outer membrane mounted to the bottom and outer walls; the membrane defining a cavity between the membrane and the walls; and a compressed air inlet so provided in one of the walls as to open in the cavity.

According to yet another aspect, there is provided a A method to pot the heads of the coils of a stator assembly including:
inserting a quantity of heat-conducting resin in a membrane;
placing a stator in the membrane; the stator including a stack of laminations provided with longitudinal slots and with a cooling surface configured to be placed in contact with a cooling body; at least one coil including straight portions inserted in longitudinal slots of the laminations; the at least one coil including longitudinally positioned heads; and a cooling body in contact with the cooling surface of the laminations;
forcing the membrane to generally conform to the stator;
allowing the heat-conducting resin to cure.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification in the appended claims, various terminology which is directional, geometrical and/or spatial in nature such as “longitudinal”, “horizontal”, “front”, rear”, “upwardly”, “downwardly”, etc. is used. It is to be understood that such terminology is used for ease of description and in a relative sense only and is not to be taken in any way as a limitation upon the scope of the present disclosure.

Other objects, advantages and features of the cooling assembly for electric machine will become more apparent upon reading of the following non-restrictive description of illustrative embodiments thereof, given by way of example only with reference to the accompanying drawings.

Generally stated, illustrative embodiments described herein are concerned with cooling assemblies that cool both the straight legs and the curved heads of prewound coils. Of course one skilled in the art will be in a position to use the cooling assemblies described herein in the design of electric machines using other types of coils. Illustrative embodiments described herein are also concerned with coil-head embedding assemblies used to embed the head of the coils in a heat transfer material.

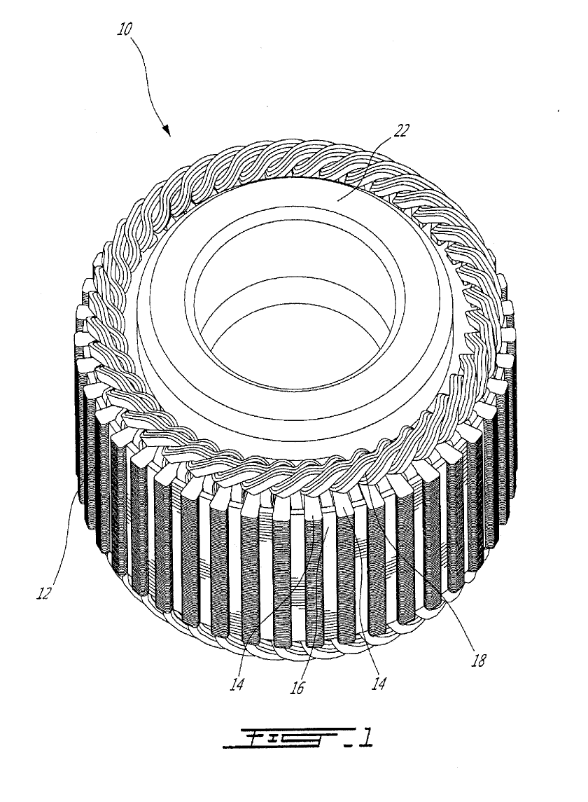

FIG. 1 of the appended drawings illustrates, in a perspective view, the stator 10 of an internal stator/external rotor electric machine (not shown). The stator 10 is made of multiple stacked laminations 12 provided with outwardly projecting teeth 14 defining coil receiving slots 16 therebetween where coils 18 are inserted.

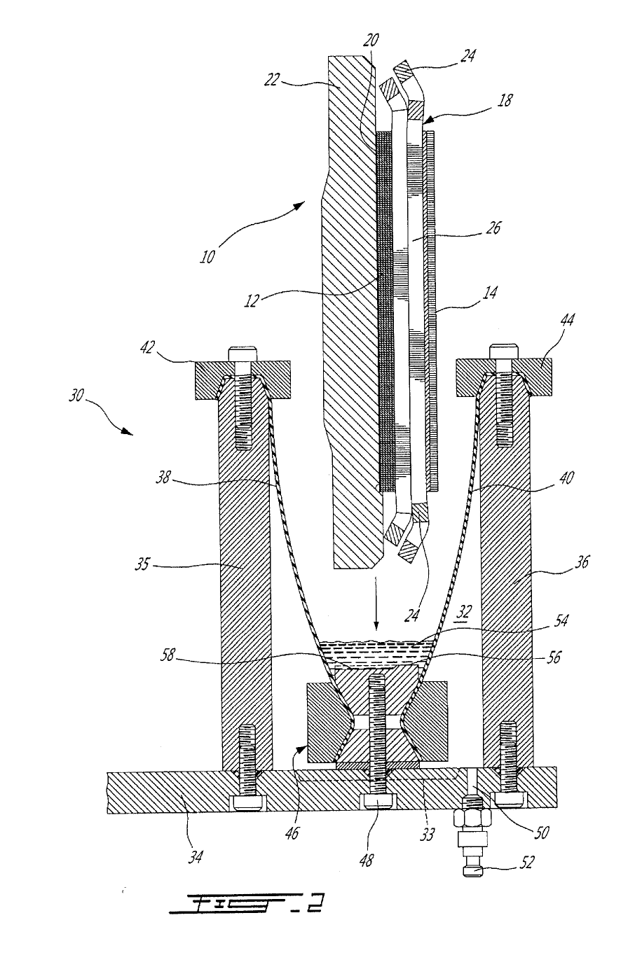

The stacked laminations 12 define a generally cylindrical internal surface 20 (see FIG. 2) so configured as to receive a cooling body 22 having a generally cylindrical outer surface therein as will be described hereinbelow.

As can be better seen on FIG. 2, the prewound coils 18 include head portions 24 interconnecting straight legs 26 of the coils. The heads 24 project outwardly from the stack of laminations 12. Accordingly, the coil heads 24 are only cooled by convection and not by direct contact with the stator 10.

The cooling assembly of the stator 10 includes the generally cylindrical cooling body 22 inserted in the stator 10 to contact the inner surface thereof to extract the heat generated by the coils 18. As a non-limiting example, a cooling fluid (not shown) could be circulated in channels (also not shown) of the cooling body 22 of the cooling assembly to extract the heat therefrom. A key and keyway arrangement (not shown) may optionally be provided between the cooling body 22 and the stator 10 to prevent relative rotation therebetween.

According to an aspect of the present disclosure, it is proposed to embed the coil heads in a heat-transfer medium that is also in contact with the cooling body 22 to thereby extract heat directly from the coil heads.

Turning now to FIG. 2 of the appended drawings a coil head embedding assembly 30 according to a first illustrative embodiment will be described.

The coil head embedding assembly 30 includes a cavity 32 defined by a bottom plate 34 and inner and outer cylindrical side walls 35, 36 fastened together. Inner and outer flexible membranes 38, 40 are respectively mounted to the free ends of the inner and outer cylindrical side walls 35, 36 via respective brackets 42, 44 fastened thereto. The membranes 38, 40 are interconnected by a cylindrical mechanical assembly 46 sealing the membranes together. The assembly 46 is mounted to the bottom wall via a fastener 48.

A contacting portion 56 of the assembly 46 includes channels 58, the purpose of which will be described hereinbelow.

Similarly, the bottom plate 34 includes channels 33 the purpose of which will be described hereinbelow.

The bottom plate 34 includes a compressed air inlet 50 to which a conventional compressed air nozzle 52 to which a compressed air source (not shown) may be attached. Of course, other types of link to a pneumatic circuit (not shown), for example of a more permanent nature could be used.

A predetermined amount of heat transfer medium, here seen in the form of a thermally conducting resin 54, is poured between the membranes 38, 40 and is intended to encapsulate the coil heads 24 and to fill the area between the heads 24 and the cooling body 22. For example, a thermally conducting resin made by Cool Polymer under number D5506 could be used. Of course, other materials, such as, for example, Duralco™ 4538 made by Cotronics Corporation could also be used.

Turning now to FIGS. 2 to 6 of the appended drawings, the operation of the coil head embedding assembly 30 will be described.

FIG. 2 shows the rotor 10 ready to be inserted in the coil head embedding assembly 30, which has been supplied with a predetermined quantity of thermally conducting resin 54.

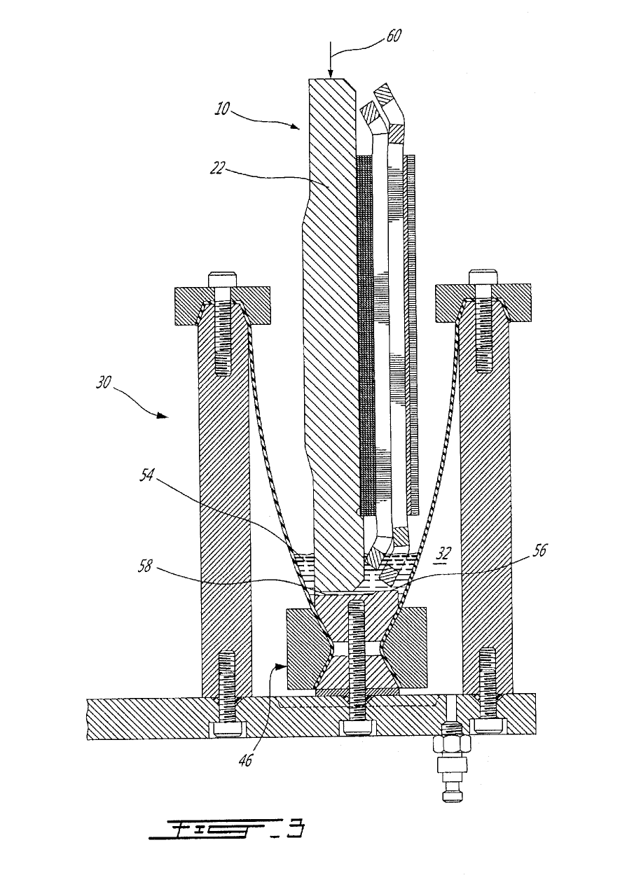

FIG. 3 shows the stator 10 inserted in the coil head embedding assembly 30. The free end of the cooling body 22 is maintained in contact with the contacting surface 56 of the mechanical assembly 46 (see arrow 60).

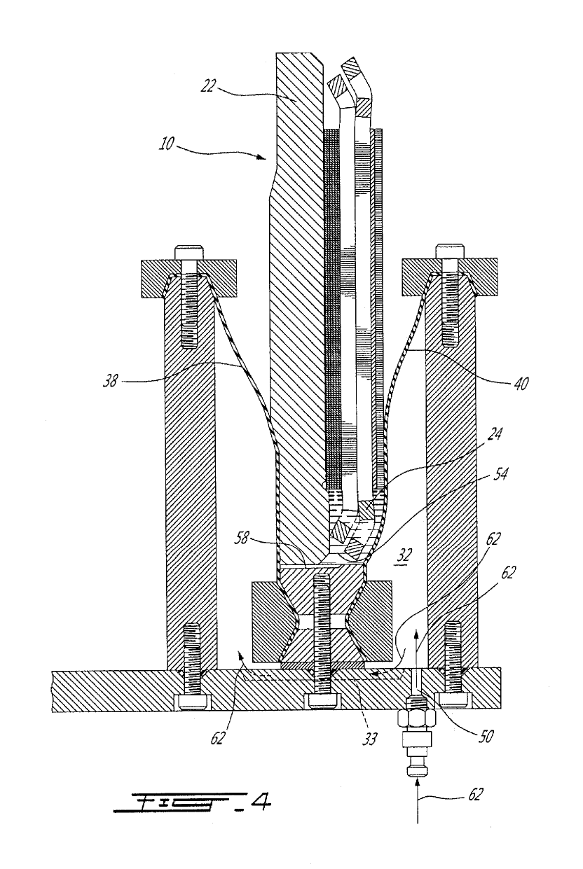

As can be seen from FIG. 4, compressed air in then supplied to the cavity 32 via the compressed air inlet 50 (see arrows 62). Thanks to the channels 33, the compressed air is applied to both membranes 38 and 40 to thereby force the membranes against the stator 10.

The channels 58 ensure that all the thermally conducting resin ends up on the coil side of the cooling body 22, embedding the coil heads 24.

As will be understood by one skilled in the art the quantity of thermally conducting resin 54 inserted in the coil head embedding assembly 30 is such that there is just enough resin to reach the laminations 14 when the compressed air pressure positions the membranes 38 and 40 as illustrated in FIG. 4.

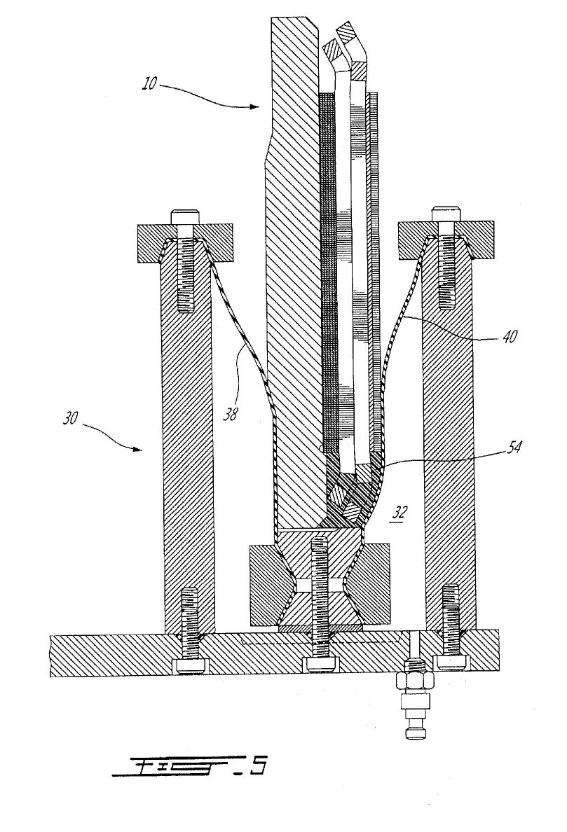

FIG. 5 illustrates the curing of the resin 54. This is done according to the specifications of the resin manufacturer, while pressured is maintained in the cavity 32.

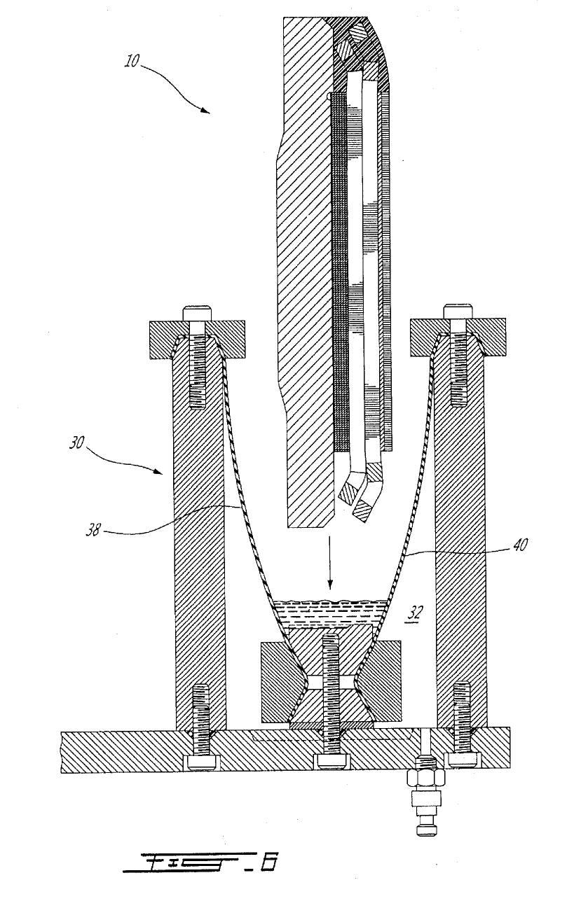

When the resin has cured, the pressure may be removed from the cavity 32, which allows the membranes 38 and 40 to return to their initial position (see FIG. 6). Then, a quantity of resin 54 may be reintroduced between the membranes 38, 40, and the coil head embedding assembly 30 is ready to embed the opposite coil heads as seen in FIG. 6. The process of FIGS. 3 to 5 is then repeated.

One skilled in the art will understand that the portions of the mechanical assembly 46 in contact with the heat-transfer medium are made of a material that will easily allow the release of the cured heat-transfer medium, or that releasing agents should be used to allow the reuse of the mechanical assembly 46. Similarly, the membranes 38 and 40 should allow the cured heat-transfer medium to be released.

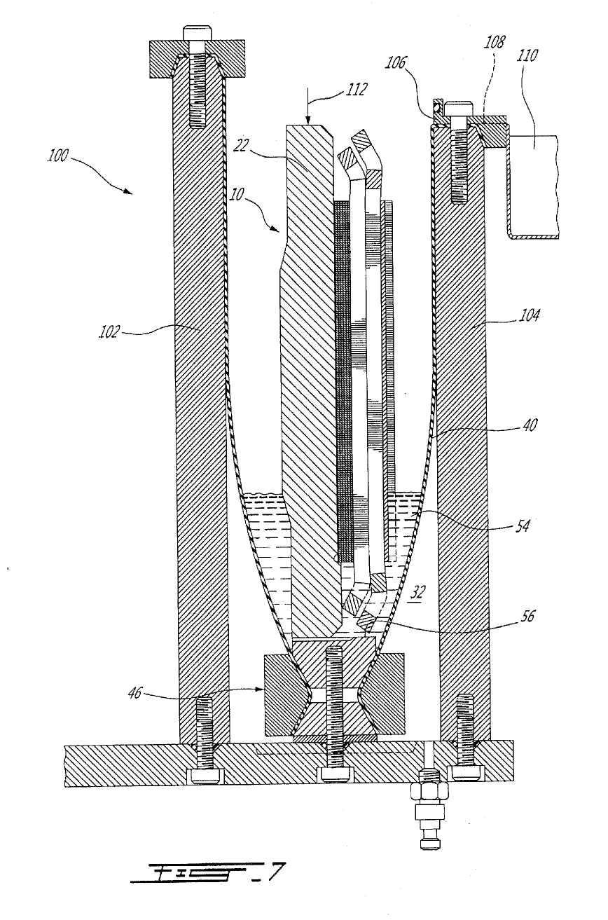

Turning now to FIGS. 7 to 10 of the appended drawings, a coil head embedding assembly 100 according to a second illustrative embodiment will be described. It is to be noted that since the coil head embedding assemblies 30 and 100 are similar, only differences therebetween will be described hereinbelow.

Generally stated, the coil head embedding element 100 is so configured as to embed the two opposite coil heads of the coils simultaneously in a heat transfer medium.

Accordingly, the side wall 102 is taller than the generally cylindrical cooling body 22 while the side wall 104 is about as high as the cooling body 22.

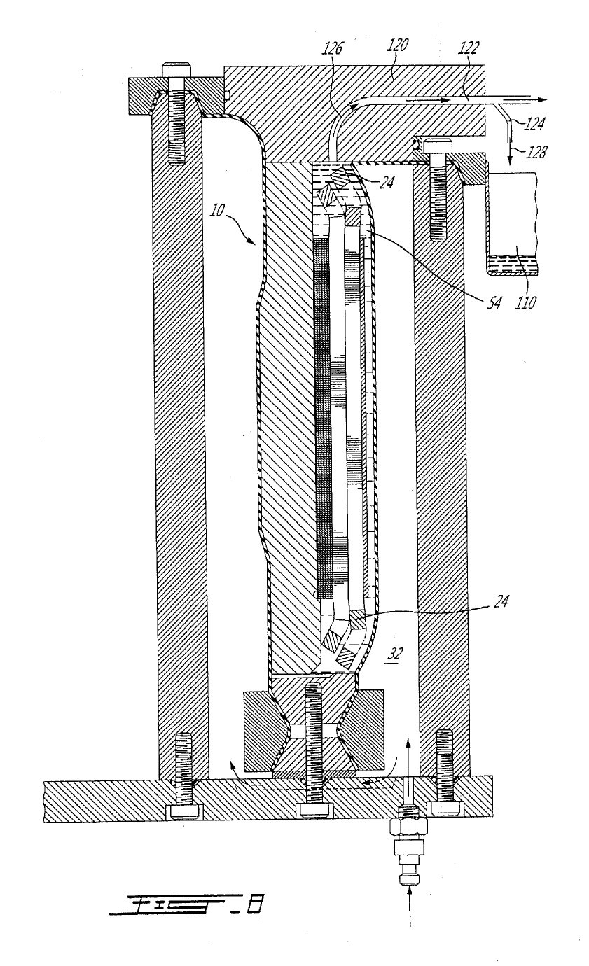

Furthermore, the coils head embedding assembly 100 includes a cover 120 (see FIG. 8) that may sealingly close the opening between the side walls 102 and 104 to allow a vacuum to be formed therebetween. The cover 120 includes a vacuum conduit 122 provided with an overflow outlet 124 allowing excess resin to be transferred to an overflow reservoir 110.

Turning now to FIGS. 7 to 10 of the appended drawings, the operation of the coil head embedding assembly 100 will be described.

FIG. 7 shows the rotor 10 already inserted in the coil head embedding assembly 100, which has been supplied with a predetermined quantity of thermally conducting resin 54. One of the free ends of the cooling body 22 is maintained in contact with the contacting surface 56 of the mechanical assembly 46 (see arrow 112), via the pressure applied by the cover 120 (See FIG. 8).

As can be seen in FIG. 8, compressed air in then supplied to the coil head embedding assembly 100 as described hereinabove, while a vacuum is formed in the space occupied by the coils and the resin.

The excess resin 54 is transferred to the overflow reservoir 110 by the vacuum and overflow channels 122 and 124 (see arrows 126 and 128).

It is to be noted that the position of the vacuum channel 122 is such that enough resin 54 remains in contact with the stator 10 to completely embed the coil heads 24.

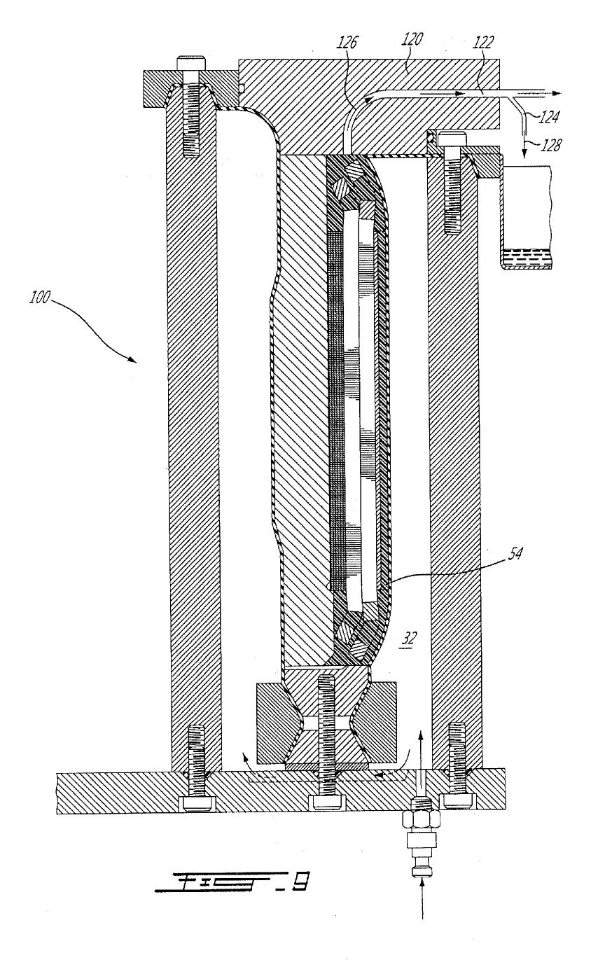

FIG. 9 illustrates the curing of the resin 54. This is done according to the specifications of the resin manufacturer, while the pressurization and vacuum are maintained. Of course, one skilled in the art will understand that the compressed air pressure and/or the vacuum could be pulsed.

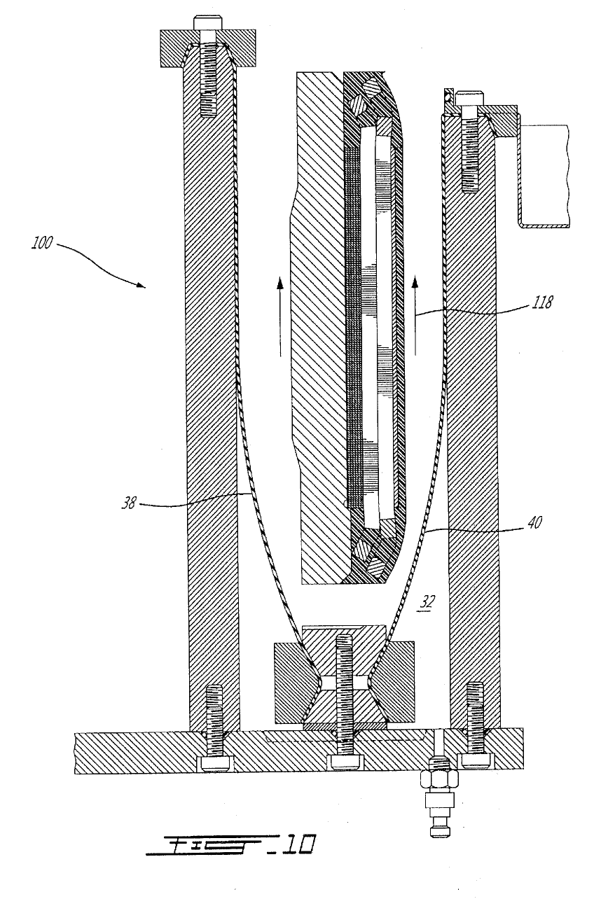

When the resin has cured, the compressed air pressure and the vacuum may be removed, which allows the membranes 38 and 40 to return to their initial position (see FIG. 10). Then, the stator 10 may be removed from the assembly 100 (see arrows 118).

It will be understood that the vacuum applied helps in the formation of a solid cured heat-conducting resin without voids therein created by trapped air therein.

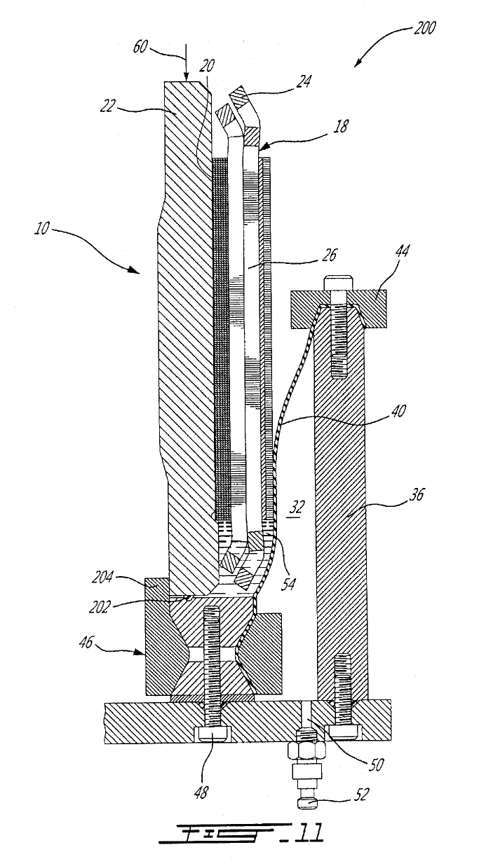

Turning now finally to FIG. 11 of the appended drawings, a coil head embedding assembly 200 according to a third illustrative embodiment will be described. It is to be noted that since the coil head embedding assemblies 200 is very similar to the coil embedding assembly 30 illustrated in FIGS. 1 to 6, only differences therebetween will be described hereinbelow.

As can be seen from this FIG. 11, the major difference between the assemblies 200 and 30 is the fact that the inner wall 35 and associated inner membrane 38 have been dispensed with. An O-ring 202 has been provided on top of the mechanical assembly 46. The cooling body 22 of the stator 10 rests on this O-ring 202 to thereby keep the resin 54 between the membrane 40 and the stator 10.

The mechanical assembly 46 has been modified to create a guide 204 to ensure the correct placement of the stator 10 with respect to the membrane 40.

It is to be noted that, when an assembly such as 200 is used, the stator 10 is maintained against the O-ring 202 (see arrow 60) before the resin is poured and the pneumatic pressure is applied.

Of course, one skilled in the art will understand that the O-ring 202 could be replaced with other type of gasket material could be used to prevent the resin 54 from dripping.

It is to be noted that while the coil head embedding assemblies have been described herein as being made of various walls fastened and sealed together, other type of construction is possible.

While a stacked lamination stator has been described herein, other stator technologies could be used. Furthermore, while a one-piece stator has been described herein, sectional stators could also benefit from the above noted techniques.

Similarly, while the stacked laminations described herein have a generally cylindrical internal surface receiving the generally cylindrical cooling assembly, other configurations for the interconnection of the cooling assembly to the stator are possible. For example, polygonal, keyed or dovetailed interconnections could be used.

While the coil head embedding assemblies described herein use a pair of membranes interconnected by a mechanical assembly, one skilled in the art will understand that other configurations could be used. For example, a single membrane adhered or otherwise maintained to the bottom wall 32 could be used.

It is also to be noted that while one compressed air inlet 52 is illustrated in the various embodiments, more than one air inlets could be used. For example, one air inlet could be provided on either side of the cylindrical mechanical assembly 46 to thereby dispense with the channel 33. Similarly, while the air inlet 52 has been shown provided on the bottom wall 34, it could be provided on one of the side walls 35 and 36.

Also, while an internal stator type electric machine was described above, a more conventional external stator electric machine could be provided with embedded coil heads as described above.

Interestingly, the use of the membrane 40 may help to regulate the position of the coil heads, which could have been slightly deformed during their insertion in the lamination slots. Indeed, the compression of the coil heads under pneumatic pressure provided by the membrane is possible. Accordingly, a stator having a more controllable outer shape is produced.

It is also to be noted that, the operation, the structure and the assembly of the generally cylindrical body of the cooling assembly has not been described herein in details. However, the general principles of the cooling assemblies described in the following patents and published patent applications could, amongst others, be used for the cooling assembly body described hereinabove.

U.S. Pat. Nos. 6,819,016; 6,960,851; 6,992,411; WO 2010/012070A1; and WO 2010/081216A1.

These documents are therefore included herein by reference in their entirety.

It is to be understood that the cooling assembly for electric machines is not limited in its application to the details of construction and parts illustrated in the accompanying drawings and described hereinabove. The cooling assembly for electric machines is capable of other embodiments and of being practiced in various ways. It is also to be understood that the phraseology or terminology used herein is for the purpose of description and not limitation. Hence, although the present cooling assembly for electric machines has been described hereinabove by way of illustrative embodiments thereof, it can be modified, without departing from the spirit, scope and nature thereof.

What is claimed is:

1. A cooling arrangement for the stator of an electric machine provided with coils including heads; the cooling arrangement comprising:
a cooling body so configured as to be placed in contact with the stator and provided with opposite longitudinal ends; and
heat-conducting material embedding the heads of the coils and contacting the cooling body.

2. A cooling arrangement as recited in claim 1, wherein the stator has a cooling surface configured to contact the cooling body and wherein the coils are prewound coils made of rectangular wire.

3. A cooling arrangement as recited in claim 2, wherein the cooling surface of the stator is generally cylindrical and wherein the cooling body is generally cylindrical.

4. A cooling arrangement as recited in claim 1, wherein the heat conducting material includes heat-conducting resin.

5. A stator of an electric machine comprising:
a stack of laminations provided with longitudinal slots and with a cooling surface configured to be placed in contact with a cooling body;
at least one coil including straight portions inserted in longitudinal slots of the laminations; the at least one coil including longitudinally positioned heads;
a cooling body in contact with the cooling surface of the laminations; the cooling body being provided with opposite longitudinal ends;
heat-conducting medium embedding the heads of the coils and contacting the cooling body.

6. A stator as recited in claim 5, wherein the coils are prewound coils made of rectangular wire.

7. A stator as recited in claim 5, wherein the cooling surface of the lamination stack is generally cylindrical and wherein the cooling body is generally cylindrical.

8. A stator as recited in claim 5, wherein the heat conducting material includes heat-conducting resin.

9. A coil head embedding assembly to embed the coil heads of the coils of a stator of an electric machine into a heat-conducting medium, the assembly comprising:
a bottom wall and an outer wall;
an outer membrane mounted to the bottom and outer walls; the membrane defining a cavity between the membrane and the walls; and
a compressed air inlet so provided in one of the walls as to open in the cavity.

10. A coil head embedding assembly as recited in claim 9, further comprising an inner wall mounted to the bottom wall and an inner membrane so mounted to the bottom and inner wall as to create a cavity therebetween.

11. A coil head embedding assembly as recited in claim 10, wherein the inner and outer membranes are integral, defining a single membrane from the inner wall to the outer wall.

12. A coil head embedding assembly as recited in claim 10, wherein the inner and outer walls are mounted to the bottom wall via fasteners.

13. A coil head embedding assembly as recited in claim 10, further comprising a mechanical assembly mounted to the bottom wall and being so configured as to interconnect the inner and outer membranes to the bottom wall.

14. A coil head embedding assembly as recited in claim 10, further comprising inner and outer brackets respectively mounting the inner and outer membranes to free ends of the inner and outer walls.

15. A coil head embedding assembly as recited in claim 9, further comprising a sealing cover to be applied to the free ends of the side walls.

16. A coil head embedding assembly as recited in claim 9, wherein the sealing cover includes a vacuum outlet.

17. A coil head embedding assembly as recited in claim 9, wherein the sealing cover further includes an overflow outlet.

18. A coil head embedding assembly as recited in claim 9, wherein the outer wall is generally cylindrical.

19. A method to pot the heads of the coils of a stator assembly including:
inserting a quantity of heat-conducting resin in a membrane;
placing a stator in the membrane; the stator including a stack of laminations provided with longitudinal slots and with a cooling surface configured to be placed in contact with a cooling body; at least one coil including straight portions inserted in longitudinal slots of the laminations; the at least one coil including longitudinally positioned heads; and a cooling body in contact with the cooling surface of the laminations;
forcing the membrane to generally conform to the stator;
allowing the heat-conducting resin to cure.

20. A method as recited in claim 19, further including drawing a vacuum from a space enclosing the coils.
